(19) United States
(12) Patent Application Publication
(10) Pub. No.: US 2009/0166568 A1
(43) Pub. Date: Jul. 2, 2009

(54) Method and Apparatus For Electromagnetic Emission By Reactive Composite Materials

(76) Inventors: Timothy P. Weihs, Baltimore, MD (US); Somasundaram Valliappan, Timonium, MD (US); Timothy Ryan Rude, Baltimore, MD (US); Ellen M. Heian, Cockeysville, MD (US); David Lunking, Rockville, MD (US); Yuwei Xun, Cockeysville, MD (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/425,766

(22) Filed: Jun. 22, 2006

Related U.S. Application Data
(60) Provisional application No. 60/692,857, filed on Jun. 22, 2005.
(60) Provisional application No. 60/692,822, filed on Jun. 22, 2005.
(60) Provisional application No. 60/740,115, filed on Nov. 28, 2005.

(51) Int. Cl. G01J 3/10

(52) U.S. Cl. 250/504 R

(57) ABSTRACT

A device and method for emitting electromagnetic radiation utilizing a reactive composite material (RCM) as an emission source. By selective modification of the reactive composite material (RCM), attributes of the emitting device, including the ability to produce specific radiation intensity levels at specific electromagnetic wavelengths, the ability to emit for a specific duration, the avoidance of dangerous reaction products, portability, geometric design flexibility, and simple, safe storage may be selected.

### CROSS-REFERENCE TO RELATED APPLICATIONS

The present application is related to, and claims priority from (1) U.S. Provisional Patent Application Ser. No. 60/692,857 filed on Jun. 22, 2005 (the '857 application); (2) U.S. Provisional Patent Application No. 60/692,822 filed on Jun. 22, 2005 (the '822 application); and (3) U.S. Provisional Patent Application No. 60/740,115 filed on Nov. 28, 2005 (the '115 application); each of which is herein incorporated by reference.

### STATEMENT REGARDING FEDERALLY SPONSORED RESEARCH

The United States Government has certain rights in this invention pursuant to Award 70NANB3H3045 supported by NIST.

### BACKGROUND OF THE INVENTION

The present invention is related generally to methods and apparatus for generating a burst of electromagnetic radiation, and in particular, to methods and apparatus for utilizing a reactive composite material to selectively generate bursts of electromagnetic radiation having predetermined spectral characteristics.

There are many occasions when a brief, bright flash of electromagnetic (EM) radiation, e.g. light, is desired. Examples include both signal and illumination applications, such as flash photography, non-lethal flash grenades, decoy and rescue flares, and calibration of photo or thermal detectors, as well as similar devices configured to emit in the infra-red spectrum. Other applications include target illumination and damage to photosensitive materials or objects. A highly exothermic chemical reaction is a convenient means of producing heat and thus photons for these and other applications. Such a chemical reaction is produced by the ignition of reactive composite materials, or RCMs.

Reactive composite materials are nanostructured materials comprising two or more solid materials with large negative heats of mixing, such as nickel and aluminum, spaced in a controlled fashion throughout a continuous, dense composite in uniform layers, local layers, islands, or particles. These materials are ignitable to support self-propagating exothermic chemical reactions. The reactions typically travel along the RCMs at speeds ranging from about 0.1 m/s to about 100.0 m/s.

Reactive composite materials may be produced by a variety of known techniques, including vapor deposition, mechanical deformation, or electrodeposition. Methods of making and using reactive composite materials are disclosed in U.S. Pat. No. 6,736,942 entitled “Freestanding Reactive Multilayer Foils” which is incorporated herein by reference and in the '822 application.

Self-propagating reactions in RCMs are driven by a reduction in chemical bond energy. Upon the application of a suitable stimulus to ignite, a local bond exchange between constituents of the RCM produces heat that is conducted through the RCM to drive the reaction. Recent developments in RCM technology have shown that it is possible to carefully control the ignition threshold as well as the heat and velocity of the reaction. For instance, it has been demonstrated that the velocities, heats, and/or temperatures of the reactions in an RCM can be controlled by varying the thicknesses or scale of the reactant regions, and that the heats of reaction can be controlled by modifying the RCM composition or by low-temperature annealing of the RCM after fabrication.

These technological advances have widened the scope of potential applications of RCMs. Important applications include: (a) reactive multilayer joining (see, for example, U.S. Published Application No. 2005-0136270 A1 which is incorporated herein by reference); (b) hermetic sealing (see, for example, U.S. Published Application No. 2004-0200736 A1 which is herein incorporated herein by reference); (c) structural elements that are capable of releasing energy (examples of which are disclosed in the '857 application and the '115 application; and (d) initiating secondary reactions, as in flares, detonators and propellant-based devices (see: the '857 application).

For some photon emission applications, a specific intensity ratio is desired. One such application is for aircraft decoy flares. An aircraft decoy flare is a device that emits infrared signals or infrared illumination to mimic an aircraft engine exhaust plume, and which may be launched from an aircraft to confuse detectors on infrared-seeking ordnance launched at the aircraft, causing the ordnance to be drawn off target. Advantageously, visible emission may be reduced to prevent detection of the decoy flare by a human observer.

In another photon emission application, such as a non-lethal flash grenade, it would be desirable to maximize visible light output. This device temporarily blinds people or animals when it is ignited. It is used to confuse or distract people or animals.

Ignition of a reactive composite material generally produces an electromagnetic emission. Accordingly it would be advantageous to provide methods for adapting reactive composite materials for use in light-emitting devices, whereby specific attributes such as (1) the ability to produce specific light intensity levels at specific electromagnetic wavelengths, (2) the ability to emit for a specific duration, (3) the avoidance of dangerous reaction products, (4) portability, (5) geometric design flexibility, and (6) simple, safe storage may be selected.

### BRIEF SUMMARY OF THE INVENTION

Briefly stated, the present invention provides a device for emitting electromagnetic radiation utilizing a reactive composite material as an emission source. By selective modification of the reactive composite material, attributes of the emitting device, including the ability to produce specific illumination intensity levels at specific electromagnetic wavelengths, emission for a specific duration, lack of dangerous reaction products, portability, geometric design flexibility, and simple, safe storage may be selected.

A method of the present invention provides for the generation of an illuminating electromagnetic radiation by initiating an energetic reaction in a body of reactive composite material. Selective alterations to the configuration of the body of reactive composite material, and selective regulation of the energetic reaction may be utilized to achieved one or more desired illumination characteristics, including emissivity, intensity, spectral distribution, and duration.

The foregoing features and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 illustrates two geometries in which electromagnetic radiation is primarily emitted normal to the surface area of a reactive composite material;

FIG. 2 is a plot of intensity versus time for a reaction of two reactive composite materials, illustrating the effect of material thickness on the reaction duration;

FIG. 3 is a plot of luminous flux versus the surface area of a reactive composite material; and

FIG. 4 is a plot of duration versus the cladding thickness of a reactive composite material.

Corresponding reference numerals indicate corresponding parts throughout the several figures of the drawings. It is to be understood that the drawings are for illustrating the concepts of the invention and are not to scale.

### DESCRIPTION OF THE PREFERRED EMBODIMENT

The following detailed description illustrates the invention by way of example and not by way of limitation. The description enables one skilled in the art to make and use the invention, and describes several embodiments, adaptations, variations, alternatives, and uses of the invention, including what is presently believed to be the best mode of carrying out the invention.

As used herein, the term “light” is used generally to refer to an electromagnetic radiation emission, and is not intended to be limited to any specific wavelength or range unless clarified as such. For example, “visible light” describes a subset of light which is visible to a human observer, generally considered to be between 400 nm and 700 nm, while “infrared light” is intended to describe light having a wavelength within the infrared portion of the electromagnetic spectrum, generally considered to be between 0.7 μm and 100 μm.

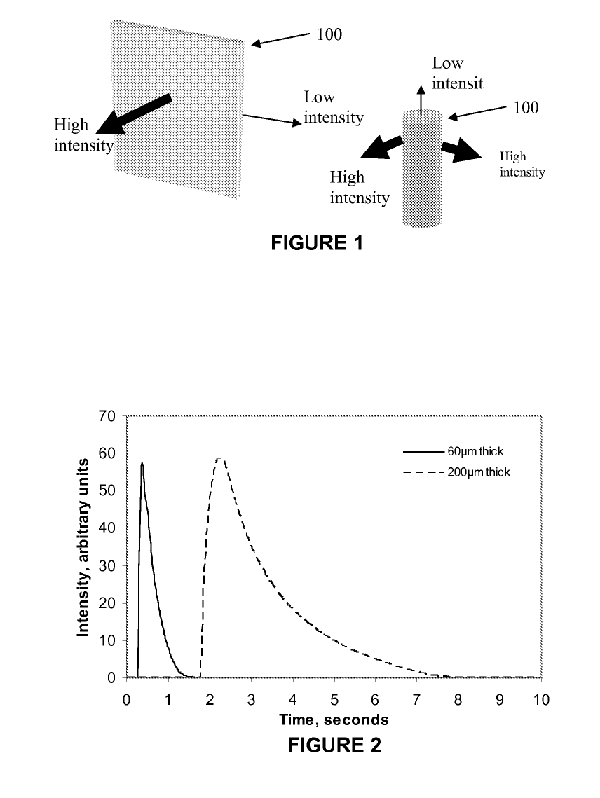

From Planck's theory of blackbody radiation, the spectral distribution and the overall intensity of light emitted from a hot object depends upon the temperature of the object. Varying the energetic reaction temperature of a reactive composite material (RCM), shown generally at 100 in FIG. 1, whether by changing the chemical reaction or by increasing or decreasing heat losses during the reaction, will thus change the spectral distribution of the light emitted.

The emissivity of the surface from which light is emitted changes the emission spectrum independent of temperature, causing deviations from the ideal blackbody distribution at any temperature. By providing a reactive composite material 100 with outer layers having different emissivities, the emission of the RCM 100 at different wavelengths (as well as the overall emission) for a given reaction temperature may be altered. These outer layers include but are not limited to metals, such as aluminum, nickel, copper, InCuSil® braze alloy, or indium; oxides, such as aluminum oxide, copper oxide, or zinc oxide; or other ceramics such as boron carbide or boron nitride. Paints and materials such as graphite can also vary the emissive properties of the RCM 100.

Control of emission at different wavelengths may also be gained by surrounding an RCM 100 with semi-transparent materials, such as transmissive plastic window films, to filter the light emitted by the RCM 100. Such polymers are used as filters, but they have not previously been considered for use with an RCM 100. These filter materials function by absorbing some wavelengths of light preferentially, changing the spectral emittance of an emission source which they surround. These films can be selectively designed to block certain wavelengths of light while having little to no effect on light emitted at other wavelengths; for instance films that transmit infrared radiation but absorb visible radiation or vice versa. In one implementation of the present invention, an RCM 100 is placed within an envelope of a polymer filter material, without being pressed directly against the polymer filter material. In another variation, an RCM 100 is manufactured by vapor deposition directly onto a film of selected polymer filter material.

The light emitted by an RCM 100 decreases as the RCM 100 cools after an energetic reaction is completed. Thus, the duration of a pulse of light from an RCM 100 may be defined as the time during which the emission at a given wavelength is above a given level. The duration of the light pulse emitted by an RCM 100 during and after a reaction depends upon the thickness of the RCM 100, the heat loss characteristics of the RCM 100 and its surroundings, and the velocity of the reaction in the RCM 100, which in turn depends on the thickness of the individual reactant layers or structures within the RCM 100.

Thicker reactant layers result in greater ignition stability and a slower reaction velocity, increasing the emission rise time and the decay time. As the reaction travels across the RCM 100, the maximum temperature is reached in the reaction zone. The maximum temperature may be observed somewhere in the RCM 100 from the moment of ignition until the reaction is complete. For most RCM applications, the reaction velocity will be much faster than the decay time, such that the effect of reaction velocity on the duration of the light pulse will be almost negligible.

Duration may be controlled by altering the volume of the RCM 100, since a larger volume of reactants produces more heat, while the luminous flux, or radiation of heat from the surface per unit time, depends only upon the surface area. Thus, more heat produced typically takes longer to radiate away. The reaction temperature is not strongly dependent on the volume of reactants, thus additional heat does not cause an increase in temperature. Conductive and convective heat losses to the surroundings also play an important role in emission duration: conduction and convection remove heat without emitting photons and can thus shorten the duration of the heat pulse.

In one embodiment of the present invention, the total light emitted and the light emitted per unit time (luminous flux) from an RCM 100 is increased by increasing the emitting area. The luminous flux emitted by an RCM 100 is limited by the surface area of the RCM 100 and the reaction temperature. Thus, device designs including specification of the surface area of the RCM 100 permit selection of total intensity or brightness of the emitted light. Similarly, the overall intensity of the light emitted may be selected by varying the reaction temperature, particularly by changing the chemical reaction or the heat losses during reaction changes.

Reactive composite materials 100 in the form of freestanding reactive multilayer foils have a two-dimensional character in that they are self-supporting but so thin that practically no light is emitted from the edges, i.e. parallel to the large surfaces of the foil, as shown in FIG. 1. In addition, the surfaces of the foil are often specular, such that the surfaces do not emit hemispherically. This behavior may be exploited to create directional radiators. A flat foil emits electromagnetic radiation normal to its surfaces. By coiling the RCM 100 into a cylinder, most radiation will be emitted radially and very little radiation axially as shown in FIG. 1. A variety of different geometries of the RCM 100 may be utilized to provide directionality to the emitted light as required by a particular illumination application.

Secondary reactions, e.g. a layer of titanium, aluminum, or a polymer on the surface of an RCM 100 burning in air, may be ignited by the RCM 100. Such secondary reactions change the emission characteristics of the RCM 100, adding heat and changing the surface emissivity during and after the secondary reaction, thus changing both duration and wavelength characteristics of the emission as well as total energy emitted. Geometries may be designed to maximize airflow past surfaces of the RCM 100 during the reaction to maximize secondary combustion reactions.

Other advantages of utilizing reactive composite material technology for electromagnetic radiation emission include several properties that make RCMs 100 safe to use. For instance, the stability of RCMs 100 against unintended ignition may be selected according to the application, permitting flexibility in storage, transport, and use (see: U.S. Published Application No. 2005-0142495 A1). The chemical reactants and reactive composite material manufacture parameters may be selected to reduce aging during long storage. Also, the products of the chemical reaction in the RCM 100 may be selected to remain in solid form at the reaction temperature, preventing ejection of molten metal particles. Further, no gas is generated during the reaction, preventing formation of a pressure pulse or explosion. For example, a nickel-aluminum multilayer foil of reactive composite material barely reaches the melting point of nickel aluminide, 1638° C., during a reaction. Thus, ignition generates no molten particles, and no gas is evolved during the Ni—Al chemical reaction, so no pressure pulse is generated. The resulting reaction products cool rapidly, reducing the risk of burns, depending on the thickness of the RCM, and the reaction product is NiAl, an inert intermetallic compound. When cool, the reaction products may be inert and non-toxic, and they may crumble easily, producing no sharp edges.

In one embodiment of the invention, an RCM 100 is manufactured with selected outer layers to create desired graybody spectra. As an example, pieces of mechanically formed Ni—Al reactive composite material 100 which is 200 μm thick were clad with layers of aluminum (12.7 μm thick) on the exterior surfaces. Some of these RCM 100 pieces were then anodized to grow a layer of aluminum oxide that was then dyed black. This RCM 100 was tested with no added surface layers (i.e. the surface was aluminum in places and nickel in places, in layers less than 1 μm thick), clad with a 12.7 μm layer of aluminum, and with an anodized aluminum (aluminum oxide) surface layer. Table I compares the maximum average intensity of electromagnetic radiation released during an ignition reaction in two wavelength bands, 7.5 μm-13 μm and 320 nm-1100 nm, for these three different outer surfaces. Adding aluminum to the surface of the RCM 100 reduced the infrared light intensity to 72% and the visible light intensity to 92% of the bare light intensity, such that the ratio of infrared to visible light was 0.78. In contrast, a black anodized aluminum layer on the surface increased the infrared light intensity to 180% and visible light intensity to 108% of the bare light intensity, such that the ratio of infrared to visible light was increased to 1.67. A variety of different surface coatings for an RCM 100 may be utilized to achieve desired effects on the resulting ignition illumination.

TABLE I
Infrared and visible intensity for two outer layers, referenced
to the intensity of an RCM without an outer layer

| | Intensity (normalized to bare RCM) | | |
|---|---|---|---|
| | | Visible and | |
| | Far infrared | near-visible | Ratio |
| Outer layer | 7.5 μm-13 μm | 320-1100 nm | Infrared/visible |
| Bare | 1 | 1 | 1 (normalized) |
| Aluminum clad | 0.72 | 0.92 | 0.78 |
| Anodized aluminum | 1.80 | 1.08 | 1.67 |

In another embodiment of the invention, semi-transparent materials, i.e. transmissive plastic window films identified as Film 2041, Film 2115, Film 2056 and Film 2111 manufactured by Kube Electronics, Ltd., were placed around an RCM 100 to filter the light emitted by the RCM 100 during an ignition reaction. Table II compares the effect of these films on emittance from a Ni—Al vapor-deposited RCM, 60 μm thick. Different films reduced the infrared and visible emission by different amounts. Film 2056 and Film 2041 decreased the infrared light intensity to nearly the same fraction, but reduced visible light intensity by very different amounts. Film 2115 had a much larger effect on infrared light intensity than it had on visible light intensity, while Film 2111 reduced the infrared light intensity only slightly while reducing visible light intensity by over half. The corresponding ratios of infrared to visible light intensity thus vary widely from the case without a filter. Selection of a filter polymer having specific spectral absorptivity will enable an RCM 100 to be selected and modified to produce a desired illumination spectrum and intensity.

TABLE II
Infrared and visible intensity for four filters, referenced
to the intensity of an RCM without a filter

| | Intensity (normalized to RCM without a filter) | | |
|---|---|---|---|
| | | Visible and | |
| | Far infrared | near-visible | Ratio |
| Filter | 7.5 μm-13 μm | 320-1100 nm | Infrared/visible |
| No filter | 1 | 1 | 1 (normalized) |
| Film 2041 | 0.57 | 0.35 | 1.63 |
| Film 2115 | 0.10 | 0.31 | 0.32 |
| Film 2056 | 0.58 | 0.10 | 5.8 |
| Film 2111 | 0.81 | 0.45 | 1.8 |

The volume or overall thickness of the RCM 100 for a given surface area affects the duration of light emission because a larger reactant volume produces more heat. With more heat to dissipate through the same surface area, the reactive composite material stays hot longer. The reaction temperature is not strongly dependent on volume of reactants, thus the additional heat increases the duration of emission more than it affects the wavelength. FIG. 2 illustrates infrared radiation emitted (between 7.5 μm and 13 μm) versus time for two samples of an RCM 100, 60 μm and 200 μm thick. The resulting maximum light intensities are the same, but the thicker sample of RCM 100 radiates for a longer period of time. In the thicker sample of RCM 100, the intensity is greater than 10 for a period of 3.14 seconds while in the thinner sample of RCM 100, the intensity is greater than 10 for a period of only 0.65 seconds.

Alternative methods of the present invention for controlling the duration of emission depend on control of heat losses from the RCM 100. In one embodiment, a foil of reactive composite material 100 wrapped into a hollow cylindrical shape (as shown in FIG. 1) radiates both inward and outward upon ignition. The heat radiated inward keeps the cylinder hot, lengthening the emission duration. Alternatively, a reflective surface may be used around portions of the RCM 100 to contain and direct the resulting light emission.

In another embodiment, a foil of reactive composite material 100 is held against a plate of metal to act as a heat sink. In addition, adding a layer, such as a sheet of aluminum foil or a vapor-deposited layer, to the outside of the RCM 100 will effectively pull and trap heat, lengthening the duration of emission while reducing the maximum light intensity and the emitted intensity at shorter wavelengths. For example, FIG. 4 plots the length of time the clad surface of an RCM spent above 300° C. versus the cladding thickness for four different clad metals: aluminum, nickel, copper, and Sn-3.8 Ag solder. This plot is based on a numerical model of heat dissipation in an RCM and radiation from the surface after reaction and accounts for the density and heat capacity of the clad metals.

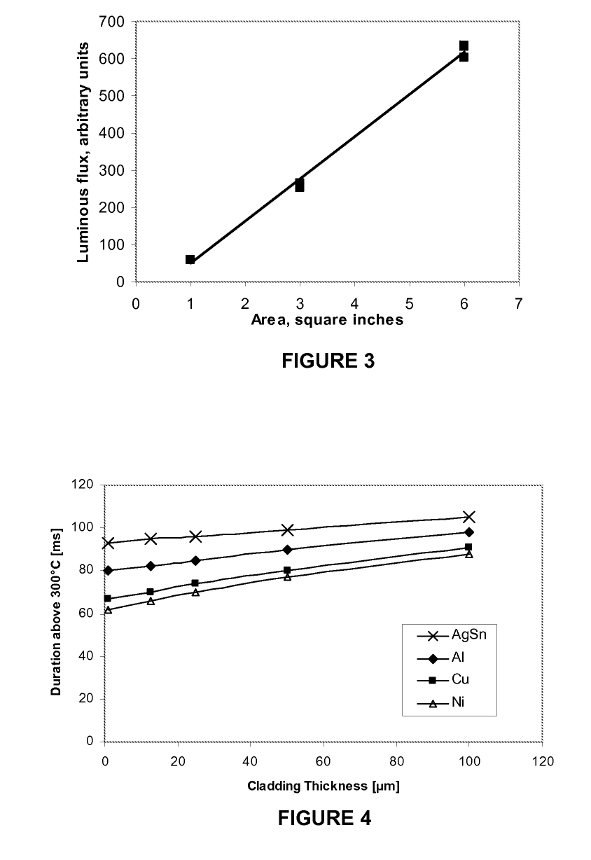

In another embodiment, the proportional relationship of the overall luminous flux or brightness of the ignited RCM 100 to the RCM surface area is utilized to achieve a desired illumination characteristic. As the surface area of the RCM 100 is increased the overall light intensity output is increased, as shown in FIG. 3 for an RCM 100 comprising a vapor-deposited Ni—Al multilayer foil 60 μm thick. Accordingly, by modifying the surface configuration of an RCM 100, the intensity of the emitted electromagnetic radiation may be selectively altered.

Similarly, in another embodiment of the present invention, a foil of a reactive composite material 100 is used to emit electromagnetic radiation primarily in a direction which is normal to the foil surfaces. For example, an RCM 100 having a surface area of one square inch was ignited, and the emitted radiation was detected and recorded (at 7.5-13 μm wavelength range) both face-on and edge-on. The maximum instantaneous luminous flux when viewed from the edge was only 12% of the instantaneous luminous flux observed when viewed from the face of the RCM 100. The total energy measured edge-on was 11% of the total energy measured face-on. Accordingly, by modifying the geometric configuration of an RCM 100, the directionality of the emitted electromagnetic radiation may be selectively altered. For example, by rolling a foil of reactive composite material 100 into a cylinder as shown in FIG. 1, differences in instantaneous luminous flux and total emitted energy between the radial direction and the axial direction may be achieved.

In another embodiment of this invention, an RCM 100 may be clad or otherwise coated with a metal that burns in air, such as, but not limited to, titanium, zirconium, hafnium, and aluminum. The resulting combination of the RCM 100 and metal burns more brightly in air and has a higher surface temperature than a similar RCM 100 without such a coating.

In a variation of the present invention, the ignition characteristics of an RCM 100 may be modified by altering the surface layer on the RCM 100. For example, an RCM 100 such as those illustrated in Table I, coated with an aluminum cladding or anodizing, are more difficult to ignite electrically than an RCM 100 having uncoated surfaces.

In another embodiment of this invention, the reaction characteristics of an RCM are selected for long-term stability by choice of chemical reaction and layer thickness, enabling a product to be produced which will have a long shelf life.

As various changes could be made in the above constructions without departing from the scope of the invention, it is intended that all matter contained in the above description or shown in the accompanying drawings shall be interpreted as illustrative and not in a limiting sense.

1. An electromagnetic radiation emitter, comprising:
a reactive composite material, said reactive composite material configured to emit electromagnetic radiation during an energetic reaction;
wherein said electromagnetic radiation has at least one characteristic having a predetermined value, said characteristic selected from a set of characteristics including spectral distribution, wavelength, intensity, duration, and directionality.

2. The electromagnetic radiation emitter of claim 1 further including at least one surface layer on said reactive composite material; and
wherein said at least one surface layer is selected to alter at least one characteristic of electromagnetic radiation emitted during an energetic reaction of said reactive composite material, said characteristic selected from a set of characteristics including luminosity, intensity, emissivity, spectral distribution, and duration.

3. The electromagnetic radiation emitter of claim 2 wherein said at least one surface layer is selected to alter an intensity for at least one selected wavelength of electromagnetic radiation emitted during an energetic reaction of said reactive composite material.

4. The electromagnetic radiation emitter of claim 2 wherein said at least one surface layer comprises a ceramic material.

5. The electromagnetic radiation emitter of claim 2 wherein said at least one surface layer comprises a metal.

6. The electromagnetic radiation emitter of claim 2 wherein said at least one surface layer has a thickness greater than 1 μm.

7. The electromagnetic radiation emitter of claim 2 wherein said at least one surface layer comprises an oxidized metal.

8. The electromagnetic radiation emitter of claim 2 wherein said at least one surface layer is selected to alter an intensity of said electromagnetic radiation having wavelengths between 0.7 μm and 100 μm.

9. The electromagnetic radiation emitter of claim 2 wherein said at least one surface layer is selected to alter an intensity of said electromagnetic radiation having wavelengths between 400 nm and 700 nm.

10. The electromagnetic radiation emitter of claim 2 wherein said at least one surface layer is selected to react with ambient oxygen to alter said at least one characteristic of electromagnetic radiation emitted during an energetic reaction.

11. The electromagnetic radiation emitter of claim 2 wherein said at least one surface layer is selected to alter a ratio of intensity between two or more wavelength bands of electromagnetic radiation emitted during an energetic reaction.

12. The electromagnetic radiation emitter of claim 1 further including a filter in proximity to said reactive composite material, said filter configured to alter a characteristic of electromagnetic radiation emitted during an energetic reaction of said reactive composite material.

13. The electromagnetic radiation emitter of claim 12 wherein said filter is a semi-transparent polymer filter.

14. The electromagnetic radiation emitter of claim 12 wherein said filter is secured to said reactive composite material.

15. The electromagnetic radiation emitter of claim 1 further including a heat sink in operative proximity to said reactive composite material, said heat sink configured to draw heat from said reactive composite material during and after an energetic reaction, whereby said emission of electromagnetic radiation is reduced.

16. The electromagnetic radiation emitter of claim 1 wherein said reactive composite material is disposed in a configuration to retain heat during an energetic reaction, whereby the duration of said emission of electromagnetic radiation is increased.

17. The electromagnetic radiation emitter of claim 1 wherein said emission of electromagnetic radiation is not associated with generation of a gas.

18. The electromagnetic radiation emitter of claim 1 wherein said emission of electromagnetic radiation is not associated with generation of a pressure pulse.

19. The electromagnetic radiation emitter of claim 1 wherein said emission of electromagnetic radiation is not associated with an ejection of reaction debris.

20. The electromagnetic radiation emitter of claim 1 wherein said energetic reaction reduces said reactive composite material to an inert material.

21. The electromagnetic radiation emitter of claim 1 further including a means to protect said reactive composite material against an accidental ignition of said energetic reaction.

22. The electromagnetic radiation emitter of claim 1 wherein said reactive composite material is selectively configured to provide directional illumination during said energetic reaction.

23. The electromagnetic radiation emitter of claim 22 wherein said reactive composite material is configured to emit at least 85% of said electromagnetic radiation emitted during an energetic reaction radially about a longitudinal axis.

24. The electromagnetic radiation emitter of claim 22 wherein said reactive composite material is configured to emit an amount of electromagnetic radiation parallel to a selected planar surface which is less than 15% of an amount of said electromagnetic radiation emitted normal to said selected planar surface.

25. The electromagnetic radiation emitter of claim 1 wherein the duration of said emitted electromagnetic radiation is altered by altering the volume of said reactive composite material.

26. The electromagnetic radiation emitter of claim 1 wherein said reactive composite material is selected to have a stable storage characteristic.

27. An assembly for illuminating an object, said assembly comprising a reactive composite material configured to emit electromagnetic radiation during an energetic reaction.

28. The assembly of claim 27 wherein at least a portion of said electromagnetic radiation is in the infrared spectrum.

29. An assembly for providing an electromagnetic signal, said assembly comprising a reactive composite material configured to emit electromagnetic radiation during an energetic reaction.

30. The assembly of claim 29 wherein at least a portion of said electromagnetic radiation is in the infrared spectrum.

31. A method for providing electromagnetic radiation, comprising:
providing a reactive composite material;
initiating an energetic reaction in said reactive composite material, said reactive composite material emitting electromagnetic radiation during said energetic reaction; and
controlling at least one characteristic of said emitted electromagnetic radiation.

32. The method of claim 31 wherein said at least one characteristic is controlled by altering a temperature of said energetic reaction.

33. The method of claim 32 wherein said step of controlling includes cooling said reactive composite material during said energetic reaction.

34. The method of claim 32 wherein said step of controlling includes heating said reactive composite material during said energetic reaction.

35. The method of claim 32 wherein said step of controlling a characteristic of said emitted electromagnetic radiation includes altering a property of said reactive composite material, said property selected from a set of properties including dimensions, chemical composition, and geometric configurations.

36. The method of claim 31 wherein said step of controlling a characteristic of said emitted electromagnetic radiation includes applying a surface coating to said reactive composite material.

37. The method of claim 31 wherein said step of controlling a characteristic of said emitted electromagnetic radiation includes initiating a secondary energetic reaction in proximity to a surface of said reactive composite material.

38. The method of claim 31 further including the step of surrounding the reactive composite material with a filter to alter at least one emissive characteristic of said emitted electromagnetic radiation.
